(19) United States
(12) Patent Application Publication
(10) Pub. No.: US 2026/0162559 A1
(43) Pub. Date: Jun. 11, 2026

(54) WALKABLE MODULAR STRUCTURE FOR THE REALIZATION OF PSYCHOMOTOR PATHS

(71) Applicant: ARTELLIGENZA SRL-SB, Modena (MO) (IT)

(72) Inventors: Serena PAIOLI, Modena (IT); Ruben AMADORI, Lama Mocogno (MO) (IT); Cristiano ROSAFIO, Modena (IT); Sara SCARABELLI, Granarolo (BO) (IT)

(73) Assignee: ARTELLIGENZA SRL-SB, Modena (MO) (IT)

(21) Appl. No.: 19/129,056

(22) PCT Filed: Nov. 9, 2023
(86) PCT No.: PCT/IB2023/061335

§ 371 Date: May 12, 2025

(30) Foreign Application Priority Data
Nov. 10, 2022 (IT) 102022000023217

(51) Int. Cl. G09B 19/00; A47D 13/04; A63B 23/04

(52) U.S. Cl. CPC G09B 19/003; A47D 13/04; A63B 23/04

(57) ABSTRACT

A walkable modular structure for the realization of psychomotor paths has beam elements and junction elements; the beam elements and the junction elements are removably coupled so as to define one or more psychomotor paths inside which each beam element defines a path section; the modular structure has, further, height adjusting elements for varying vertically the position of a beam element with respect to the junction elements coupled therewith. A modular structure is thus obtained with great configurability that is simple, practical, low cost, and suitable for various purposes and applicational settings.

### FIELD OF THE INVENTION

The present invention relates to a modular structure for the realization of psychomotor paths suitable for being walked upon, that is intended for use both in playing and/or education and therapeutically.

### PRIOR ART

Psychomotricity is the set of interactions between motor, sensory and cognitive functions. This meshing is, in particular, particularly strong in very young children where the development of one of the functions can be facilitated or hindered by the maturation of the others.

An excellent way of developing the psychomotricity of a child are the so-called psychomotor paths, through which the child succeeds in developing its psychomotricity during play.

Usually, the psychomotor paths are carried out within an educational setting (e.g. during the years spent in nursery school) or within a therapeutic setting; nevertheless, these paths can also be carried out very well at home, in fact today easily assemblable path kits are available on the market.

However, the configurability of these kits, is very limited, decreasing the long-term efficacy thereof and, at the same time, making the kits hardly suitable for therapeutic activities during which it is particularly important to adapt the path to the patient.

It is accordingly important to find a solution that is able to ensure great configurability and, at the same time, is very simple and practical to assemble in combination with a low cost.

It would be further desirable for this solution to be adopted both for play and/or educational and for therapeutic purposes, both in a domestic setting, even in restricted spaces, and in a medical setting.

### OBJECTS OF THE INVENTION

The main object of the present invention is to propose a modular structure for the realization of psychomotor paths that has great configurability, maintaining, at the same time, simple and practical assembly.

Another object of the present invention is that the aforesaid modular structure has a limited cost.

A further object of the present invention is that the aforesaid modular structure is suitable for various purposes and applicational settings.

### SHORT DESCRIPTION OF THE INVENTION

Such objects are achieved by a modular structure for the realization of psychomotor paths in accordance with the first claim.

### SHORT DESCRIPTION OF THE DRAWINGS

The invention can be better understood with reference to the attached drawings that illustrate a non-limiting exemplary embodiment thereof in which:

FIG. 1 is a perspective view of an assembled modular structure according to the invention with removed elements;

FIG. 2 is a perspective view of two junction elements of the modular structure of FIG. 1, having a different thicknesses from one another;

FIG. 3 is a perspective view of two “C”-shaped junction elements with different thicknesses;

FIG. 4 is a perspective view of two semicircular shims of the modular structure of FIG. 1, having a different height from one another;

FIG. 5 is a perspective view of three simple pin elements of the modular structure of FIG. 1, having a different length from one another;

FIG. 6 is a perspective view of two pin elements with bracket of the modular structure of FIG. 1, having a different length from one another;

FIG. 7 is a perspective view of two beam elements of the modular structure of FIG. 1, having a different thicknesses from one another;

FIG. 8 is a perspective view of two other beam elements of the modular structure of FIG. 1, having a different thicknesses from one another;

FIG. 9 is a perspective view of a further beam element;

FIG. 10 is a perspective view of a further modular structure provided with the further beam element of FIG. 9.

### DETAILED DESCRIPTION OF THE INVENTION

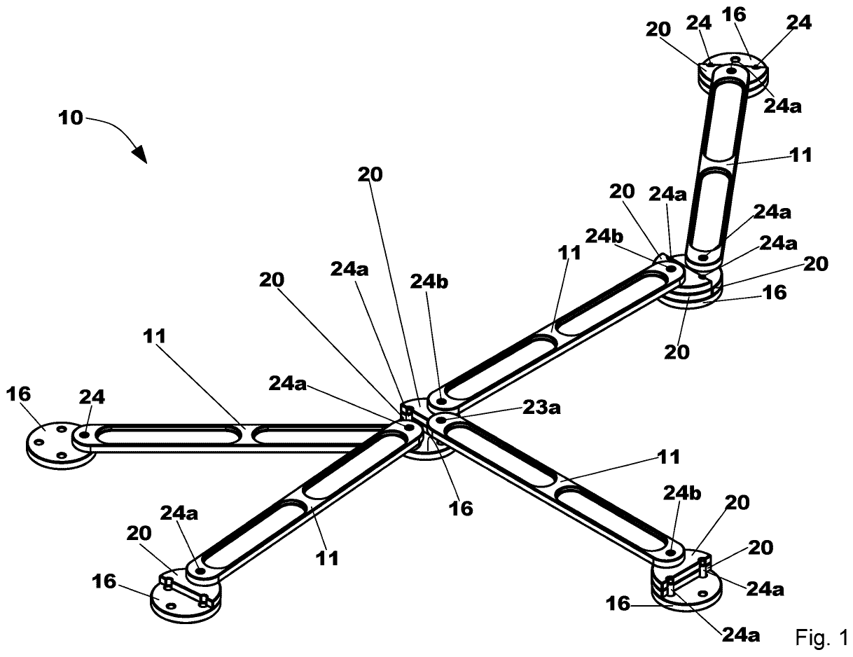

With reference to FIG. 1, the illustrated modular structure, indicated generically by 10, for the realization of psychomotor paths, includes beam elements 11 and junction elements 16 removably coupled together so as to define one or more psychomotor paths on which it is possible to walk. In the figure, the beam elements 11 are identical to one another and, in the same way, also the junction elements 16 are identical.

For the coupling between the beam elements 11 and the junction elements 16, the modular structure 10 shown in FIG. 1 includes pin elements 23a;24;24a;24b inserted removably into respective coupling holes of the beam elements 11 and of the junction elements 16.

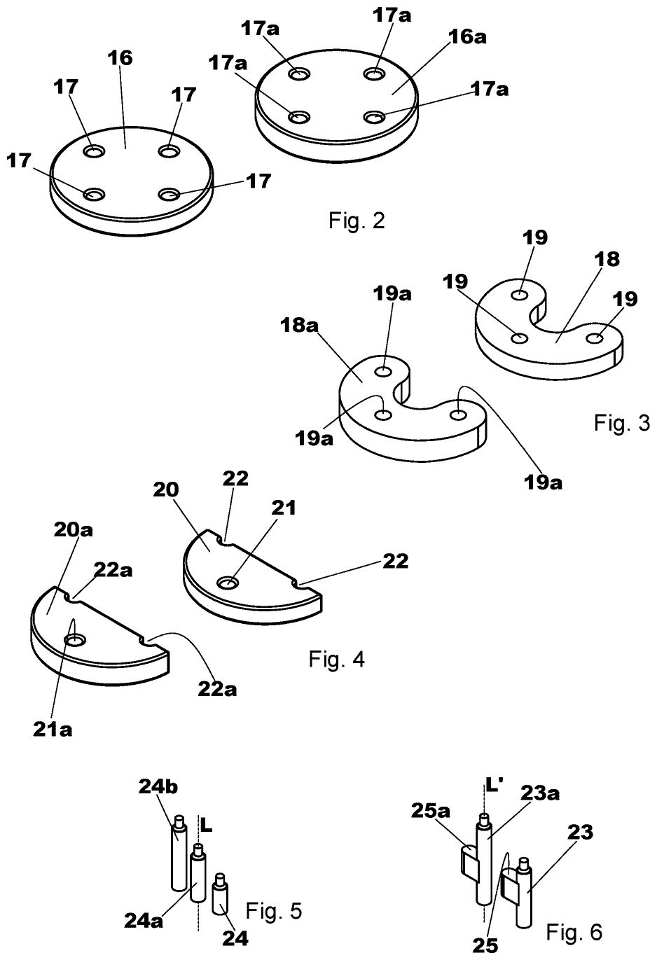

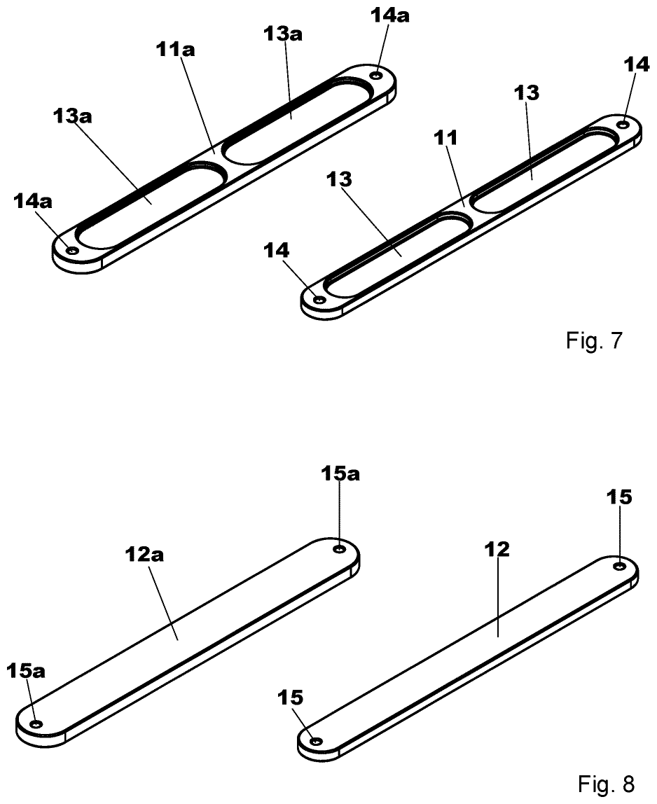

In still further detail, as shown in FIG. 2, the junction element 16 is provided with four coupling holes 17. Otherwise, with reference to FIG. 7, the beam element 11 is provided with two coupling holes 14.

As shown in FIG. 1, each beam element 11 defines, within the psychomotor path carried out by the modular structure 10, a section of the path; in particular, in the embodiment shown by way of example, the beam elements 11 are rectilinear and, thus, define two rectilinear sections of the path.

Each beam element 11 has a width that is such as to provide a rest base for a foot, such that a user can walk on each beam element 11. For this purpose, the minimum width of each beam element 11 is 10 cm, i.e. each beam element 11 has a width of at least 10 cm.

Each beam element 11 has a length that can be, for example, about 1 m.

The junction elements can be of various shapes and thicknesses; in particular, as visible in FIG. 1, and with greater detail in FIG. 2, the junction element 16 has a circular plan shape, in particular the junction element 16 is a discoid junction element 16. Further, the discoid junction elements can have different thicknesses. In the present embodiment, as shown in FIG. 2, two different discoid junction elements 16 and 16a are provided, in particular a discoid junction element of lesser thickness 16 and a discoid junction element of greater thickness 16a.

A possible different embodiment of the junction elements is shown in FIG. 3; in particular, they are “C”-shaped junction elements 18;18a. The “C”-shaped junction elements 18;18a are provided with three coupling holes 19;19a. In the present embodiment, two different “C”-shaped junction elements 18;18a are provided, in detail a “C”-shaped junction element of lesser thickness 18 and a “C”-shaped junction element of greater thickness 18a.

Also the beam elements can have different shapes and thicknesses; in detail, as visible in FIG. 1, and with greater detail in FIG. 7, the beam element 11 has hollow portions 13 in order to guide the crossing of the psychomotor path, i.e. it is a hollow beam element 11. In addition, the hollow beam elements can have different thicknesses. In the present embodiment, two different hollow beam elements 11 and 11a are provided, in particular a hollow beam element of lesser thickness 11 and a hollow beam element of greater thickness 11a that has hollow portions 13a.

In the hollow portions 13, 13a, sensory perception material can be arranged including, for example, rough material, smooth material, soft material, etc.

Another different embodiment of the beam elements is shown in FIG. 8; in particular, they are smooth beam elements 12;12a, i.e. beams devoid of hollow portions. The smooth beam elements 12;12a are provided with two coupling holes 15;15a. In the present embodiment, two different smooth beam elements 12;12a are provided, in detail a smooth beam element of lesser thickness 12 and a high smooth beam element of greater thickness 12a.

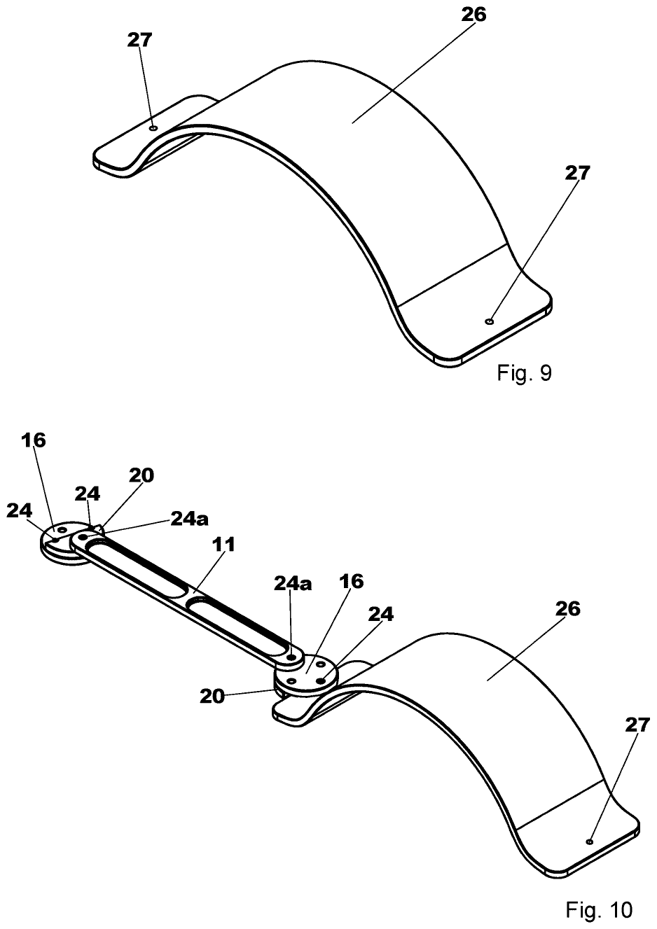

In addition, in FIG. 9 a further different embodiment of the beam element is shown: it is an arched smooth beam element of lesser thickness 26 which is also provided with two coupling holes 27.

With reference to FIG. 1, the modular structure 10 also includes height adjusting elements for varying vertically the position of a beam element with respect to the junction elements coupled therewith.

The height adjusting elements, in detail, include one or more shims 20, which in the case of the modular structure 10 of FIG. 1 are identical to one another, positioned between the hollow beam elements of lesser thickness 11 and the discoid junction elements of lesser thickness 16.

As shown in FIG. 1, the modular structure 10 further includes pin elements 23a;24;24a;24b for correct positioning of the shims 20: in fact, as shown in detail in FIG. 4, the shim 20 is not only provided with a respective coupling hole 21 inside which a pin element is inserted removably to removably couple the shim 20, in turn, with the beam elements and the junction elements between which the shim 20 is placed, but also has recesses 22 for housing at least partially the pin elements so as to ensure positioning thereof.

With reference to FIG. 4, the shim 20 has a semicircular plan shape.

Further, the shims can be made with different heights. In detail, in the present embodiment, there are different thicknesses 20 and 20a, in particular a low shim 20 and a high shim 20a.

Also the pin elements can have different shapes and lengths.

In particular, with reference to FIGS. 5 and 6, the pin elements are of two types: simple pin elements 24;24;24b, i.e. pin elements having cylindrical symmetry with respect to an axis of longitudinal extent L (that has been shown for only one of the simple pin elements for the sake of simplicity), and pin elements with bracket 23;23a, i.e. pin elements that have bracket 25;25a, at a portion of the pin element with bracket 23;23a, that extends radially with respect to an axis of longitudinal extent L′ (that, also in this case, for the sake of simplicity, has been shown for only one of the pin elements with bracket) and interrupts the cylindrical symmetry of the pin element with bracket 23;23a with respect to the axis of longitudinal extent.

Still more in particular, in the embodiment shown in FIG. 5, the aforesaid simple pin elements 24,24a,24b have three different lengths, i.e. short 24, medium 24a, and long 24b, simple pin elements are provided, whereas the aforesaid pin elements with bracket 23;23a have two different lengths, i.e. there are short 23 and long 23a pin elements with bracket.

An example will be disclosed by means of which it will be clear how to choose the type of pin element to be used.

The modular structure 10 is made of a suitable walkable material, for example of a wooden material.

In particular, each beam element 11 includes an upper portion suitable for being walked upon, i.e. on which it is possible to walk. The hollow portions 13 are made, in particular, in the upper portion.

From what has been disclosed, it is clear the possible configurations that can be adopted by the modular structure 10 are extremely varied, thus enabling the psychomotor path to be modelled in the freest manner possible; for this reason, only one of the possible adoptable configurations will be disclosed below that however enables all the advantages of the present invention to be highlighted.

In the configuration shown in FIG. 1, the modular structure 10 has hollow beam elements of lesser thickness 11, discoid junction elements of lesser thickness 16, and low shims 20, whereas the pin elements are both simple and with bracket.

This particular configuration, in detail, enables the importance of the variety of the pin elements to be highlighted.

In particular, the short simple pin elements 24 are inserted inside the respective coupling holes to couple a hollow beam element of lesser thickness 11 with a discoid junction element of lesser thickness 16, or are inserted inside the respective coupling holes of a discoid junction element of lesser thickness 16 and housed in the respective recesses of a low shim 20 to ensure correct positioning of the low shim 20.

The medium simple pin elements 24a, on the other hand, are inserted inside the respective coupling holes to couple respectively a hollow beam element of lesser thickness 11 with a low shim 20 and a discoid junction element of lesser thickness 16, or to couple a hollow beam element of lesser thickness 11 with another hollow beam element of lesser thickness 11 and a discoid junction element of lesser thickness 16. The medium simple pin elements 24a are further inserted inside the respective coupling holes of a discoid junction element of lesser thickness 16 and housed in the respective recesses of two low shims 20 placed on top of one another to ensure correct positioning of both shims.

Otherwise, the long simple pin elements 24b are inserted inside the respective coupling holes to couple respectively a hollow beam element of lesser thickness 11 with two low shims 20 and a discoid junction element of lesser thickness 16.

Lastly, it should be noted that the long pin element with bracket 23a not only contributes to ensure correct positioning of two low shims 20 but also permits coupling between a hollow beam element of lesser thickness 11 and a discoid junction element of lesser thickness 16. This function is not obtainable by a simple pin element: in fact, the bracket 25a (which in the specific case is hidden by the hollow beam element of lesser thickness 11 in the figure taken into consideration) ensures a support on the hollow beam element of lesser thickness 11, thus permitting secure coupling. In the case (which is not shown) on the other hand of only one low shim 20 instead of two low shims 20 being present the long pin element with bracket 23a would have to be replaced by the short pin element with bracket 23.

It is important to note that by using two “C”-shaped junction elements of lesser thickness 18 instead of two low shims 20, it would have been possible to use a long simple pin element 24b for coupling the hollow beam element of lesser thickness 11 with the discoid junction element of lesser thickness 16 and the same “C”-shaped junction elements of lesser thickness 18.

The aforesaid configuration enables a series of (step) level differences to be obtained between the hollow beam elements of lesser thickness 11, and thus between respective sections of psychomotor path, which cover a key role from the psychomotor point of view.

The modular structure of FIG. 10 shows the use of the arched smooth beam element of lesser thickness 26, which enables a continuous level variation to be obtained that, unlike the previous case, is made inside the respective section of psychomotor path.

Similarly to what has been disclosed previously, the coupling between the arched smooth beam element of lesser thickness 26 and the discoid junction element of lesser thickness 16 is carried out by inserting a short simple pin element 24 inside the respective coupling holes.

It is clear that the analogy also extends to all the other couplings disclosed above: for example, coupling (not shown) of an arched smooth beam element of lesser thickness 26 with a discoid junction element of lesser thickness 16 and a low shim 20 is carried out by inserting a medium simple pin element 24a inside the respective coupling holes 17,21,27.

The arched smooth beam element of lesser thickness 26, in addition, can also act as an armchair by placing the body in the concave part or can be used for gymnastic exercises in general (fitness, yoga, etc.).

The modular structure for the realization of psychomotor paths that has just been disclosed is highly configurable and is at the same time easy and practical to assemble.

The simplicity of the modular structure which has been disclosed enables production costs to be contained.

The modular structure which has been disclosed can be used both for play and/or educational purposes and for therapeutic purposes both in a domestic setting, also in restricted spaces and in a medical setting.

The holes to be used in the junction elements have to be at least three, whereas in the beam elements the holes to be used have to be at least two. Alternatively, to the wooden material, other materials can be used, preferably ecocompatible materials.

Variants in the configuration and in the number of components of the aforementioned modular structure are possible.

1. A walkable modular structure for the realization of psychomotor paths, including beam elements each having a width that is such as to provide a rest base for a foot and further including junction elements, said beam elements and said junction elements being removably coupled so as to define one or more psychomotor paths within which each beam element defines a path portion, and wherein height-adjusting elements are provided for vertically varying the position of a beam element with respect to the junction elements coupled therewith, said modular structure further including pin elements removably inserted into coupling holes of said beam elements and into coupling holes of said junction elements for removably coupling said beam elements and said junction elements, said height-adjusting elements including one or more shims positioned between said beam elements and said junction elements, wherein said shims are provided with respective coupling holes inside which said pin elements are removably inserted to removably couple said shims with said beam elements and with said junction elements, and wherein said shims are provided with recesses to house at least partially further pin elements so as to ensure the correct positioning of said shims, wherein said pin elements are of at least two different lengths, wherein said junction elements include discoid junction elements and wherein said shims have a semicircular plan shape and at least two different thicknesses, i.e. wherein said thicknesses include at least low shims and high shims.

2. The modular structure according to claim 1, wherein each of said junction elements is provided with at least three coupling holes and each of said beam elements is provided with at least two coupling holes.

3. The modular structure according to claim 1, wherein said junction elements include “C”-shaped junction elements.

4. The modular structure according to claim 1, wherein said junction elements are of at least two thicknesses, i.e. wherein said junction elements include junction elements of lesser thicknesses and junction elements of greater thicknesses.

5. The modular structure according to claim 1, wherein said beam elements include hollow beam elements, i.e. beam elements provided with hollow portions in order to guide the crossing of said psychomotor path, and smooth beam elements i.e. beam elements without hollow portions.

6. The modular structure according to claim 1, wherein said beam elements include straight beam elements.

7. The modular structure according to claim 1, wherein said beam elements include one or more arched beam elements.

8. The modular structure according to claim 1, wherein said beam elements are of at least two different thicknesses, i.e. wherein said beam elements include beam elements of lesser thicknesses and beam elements of greater thicknesses.

9. The modular structure according to claim 1, wherein said pin elements include simple pin elements, i.e. pin elements having a cylindrical symmetry with respect to a longitudinal extent axis, and pin elements with bracket, i.e. pin elements having a bracket, at a portion of said pin element with bracket, which extends radially with respect to a longitudinal extent axis and interrupts the cylindrical symmetry of said pin elements with bracket with respect to said longitudinal extent axis.

10. The modular structure according to claim 9, wherein said simple pin elements are of three different lengths, i.e. wherein said simple pin elements includes short simple pin elements, medium simple pin elements and long simple pin elements and wherein said pin elements with bracket are of two different lengths, i.e. wherein said pin elements with bracket include short pin elements with brackets and long pin elements with brackets.

11. The modular structure according to claim 1, made of a wooden material.

12. The modular structure according to claim 1, wherein each beam element has a width of at least 10 cm.

13. The modular structure according to claim 2, wherein said junction elements include “C”-shaped junction elements.
